(19) United States
(12) Patent Application Publication
(10) Pub. No.: US 2015/0157939 A1
(43) Pub. Date: Jun. 11, 2015

(54) Methods and Apparatuses of Game Appliance Execution and Rendering Service

(71) Applicant: Wiedong Shi, Pearland, TX (US)

(72) Inventors: Yang Lu, Pearland, TX (US); Weidong Shi, Pearland, TX (US)

(21) Appl. No.: 14/588,935

(22) Filed: Jan. 3, 2015

Related U.S. Application Data
(63) Continuation-in-part of application No. 12/544,701, filed on Aug. 20, 2009.

(51) Int. Cl. A63F 13/50

(52) U.S. Cl. CPC A63F 13/50

(57) ABSTRACT

The present invention presents methods and apparatuses of game appliance execution and rendering service. A game appliance system can start a game appliance for a client system and the client system can send input to the game appliance system via a network to control game play of the game appliance and in return receive media stream of the game appliance via a network. The game appliance system can further comprise, graphics rendering apparatus. It can comprise transceiver; the graphics accelerators; and control processing element that can be programmed to, receive graphics rendering command; schedule the received graphics rendering command to the graphics accelerators; direct the graphics accelerators to compress the rendered frame into compressed frame or video; transcode the rendered frames into streaming video; and stream said video over a network to client system.

The present application is a continuation of the U.S. application Ser. No. 12/544,701, with the title “Methods and Apparatuses of Game Appliance Execution and Rendering Service”, filed Aug. 20, 2009.

The U.S. application Ser. No. 12/544,701 is a continuation-in-part of the U.S. application Ser. No. 11/668,479 with the title “Method Apparatus of Running and Rendering Games Remotely Over Broadband Network”, filed Jan. 30, 2007, which, in turn, relates to and claims priority from the U.S. Provisional App. No. 60/763,856, with the title “Method and Apparatus of Playing and Displaying Video Game Remotely Over Broadband Network”, filed Jan. 31, 2006; and the U.S. Provisional App. No. 60/765,930, with the title “Method and Apparatus of Hosting and Rendering Video Games Remotely Over Broadband Network”, filed Feb. 07, 2006.

The U.S. application Ser. No. 12/544,701 is also a continuation-in-part of the U.S. application Ser. No. 11/965,723, with the title “Methods and Apparatuses of Scalable Pipelined Execution of Graphical Applications”, filed Dec. 27, 2007, which, in turn, relates to and claims priority from the U.S. Provisional App. No. 60/877,287, with the title “Methods and Apparatuses of Scalable Pipelined Execution of Graphical Applications”, filed Dec. 28, 2006.

The U.S. application Ser. No. 12/544,701 is also a continuation-in-part of the U.S. application Ser. No. 11/927,684, with the title “Methods and Apparatuses of Separating GUI and Graphics Frame in Remote Interactive Graphical Application Execution and Rendering”, filed Oct. 30, 2007, which, in turn, relates to and claims priority from the U.S. Provisional App. No. 60/856,190, with the title “Methods and Apparatus of Separating GUI and Graphics Frame in Remote Interactive Graphical Application Execution and Rendering”, filed Nov. 2, 2006.

The U.S. application Ser. No. 12/544,701 also claims the priority from the U.S. Provisional App. No. 61/165,789, with the title “Methods and Apparatuses of Software-Image Streaming”, filed Apr. 1, 2009.

As declared in the U.S. application Ser. No. 12/544,701, the U.S. application Ser. No. 12/544,701 incorporates, the U.S. application Ser. No. 11/668,479, the U.S. application Ser. No. 11/965,723, the U.S. application Ser. No. 11/927,684, and the U.S. Provisional App. No. 61/165,789 by reference in their entirety. The present continuation application incorporates the U.S. application Ser. No. 12/544,701 by reference, and all the U.S. applications that are incorporated by the U.S. application Ser. No. 12/544,701 by reference in their entirety.

The claims are supported by the specifications and drawings of U.S. application Ser. No. 12/544,701 which, in turn claims the priority from the U.S. Provisional App. No. 61/165,789; specifications and drawings of the U.S. application Ser. No. 11/668,479, which, in turn, claims priority from the U.S. Provisional App. No. 60/763,856, and the U.S. Provisional App. No. 60/765,930; specification and drawings of the U.S. application Ser. No. 11/965,723, which, in turn, claims priority from the U.S. Provisional App. No. 60/877,287; specifications and drawings of the U.S. application Ser. No. 11/927,684, which, in turn, claims priority from the U.S. Provisional App. No. 60/856,190. No new matters are added.

1. A method of conducting real time graphics rendering for multiple running instances of virtual machines using one or a plurality of graphics rendering apparatuses, said method comprising,
launching one or a plurality of virtual machine instances by at least one graphical application execution host wherein said graphical application execution host can execute one or a plurality of virtual machine instances;
assigning the graphics rendering workload of said virtual machine instance or virtual machine instances to at least one graphics rendering apparatus wherein said graphics rendering apparatus comprises a plurality of virtual graphics processing units; and
creating at least one graphics rendering context of said virtual machine instance and associates said graphics rendering context with a virtual graphics processing unit of the graphics rendering apparatus.

2. The method in claim 1 further comprising, assigning the graphics rendering context to at least one graphics rendering apparatus out of a collection of graphics rendering apparatuses wherein the graphics rendering apparatus comprises a plurality of virtual graphics processing units and said selected graphics rendering apparatus has the least graphics processing workload already assigned to it.

3. The method in claim 1 further comprising, assigning the graphics rendering context to at least one graphics rendering apparatus out of a collection of graphics rendering apparatuses wherein the graphics rendering apparatus comprises a plurality of virtual graphics processing units and said selected graphics rendering apparatus has the most available graphics processing resources or said selected graphics rendering apparatus has the most available graphics processing capability.

4. The method in claim 1 further comprising, assigning the graphics rendering context to at least one graphics rendering apparatus out of a collection of graphics rendering apparatuses wherein the graphics rendering apparatus comprises a plurality of virtual graphics processing units and the graphics rendering apparatus is selected in round-robin manner.

5. The method in claim 1 further comprising, randomly assigning the graphics rendering context to at least one graphics rendering apparatus out of a collection of graphics rendering apparatuses wherein the graphics rendering apparatus comprises a plurality of virtual graphics processing units.

6. The method in claim 1 further comprising, removing a graphics rendering context after the virtual machine instance is terminated by the graphical application execution host.

7. The method in claim 1 further comprising, migrating a graphics rendering context assigned to a graphics rendering apparatus to a different graphics rendering apparatus wherein said graphics rendering apparatus comprises a plurality of virtual graphics processing units.

8. The method in claim 1 further comprising, monitoring graphics rendering workload assigned to a graphics rendering apparatus or monitoring graphics rendering apparatus resource utilization wherein said graphics rendering apparatus comprises a plurality of virtual graphics processing units.

9. The method in claim 1 further comprising, computing aggregated graphics processing workload and/or resource utilization from a collection of workload and/or resource utilization measures.

10. A graphics rendering apparatus wherein said graphics rendering apparatus can be assigned at least one graphics rendering context of at least one virtual machine instance and can render output frame of the graphics rendering context according to the graphics commands sent from at least one graphical application execution host wherein said graphical application execution host executes said virtual machine instance, said graphics rendering apparatus comprising,
a plurality of virtual graphics processing units wherein said virtual graphics processing unit can render output frame or output frames according to the graphics rendering context of a virtual machine instance wherein said virtual machine instance is assigned to the graphics rendering apparatus;
graphics memory coupled with the virtual graphics processing unit; and
at least one control processing unit wherein said control processing unit can schedule graphics rendering command and/or graphics data of graphics rendering contexts of virtual machine instances to the virtual graphics processing units of said graphics rendering apparatus.

11. The apparatus in claim 10 further comprising, random access memory wherein said memory can store pending graphics commands and/or graphics data of graphics rendering contexts assigned to the virtual graphics rendering apparatus.

12. The apparatus in claim 10 further comprising, at least one image and/or video compressing component wherein said image and/or video compressing component can compress output frames rendered by the virtual graphics processing unit.

13. The apparatus in claim 10 further comprising, at least one direct memory access engine wherein said direct memory access engine can compress output frame rendered by a virtual graphics processing unit during transmission of the frame.

14. The apparatus in claim 10 wherein the graphics processing unit further comprising, at least one transceiver wherein said transceiver can transmit rendered and/or compressed output frames, and/or said transceiver can receive graphics data.

15. The apparatus in claim 10 further comprising at least one network interface wherein said network interface comprises one or a plurality of transceivers.

16. The network interface in claim 16 further comprising, at least one image and/or video compressing component wherein said image and/or video compressing component can compress frames rendered by a virtual graphics processing unit.

17. A graphics gateway wherein said graphics gateway can route graphics commands and/or graphics data of a graphics rendering context to a graphics rendering apparatus or another graphics gateway wherein the graphics rendering context is associated with a virtual machine instance, and wherein the graphics commands and/or graphics data of the graphics rendering context is sent from a graphical application execution host wherein said virtual machine instance is executed, and wherein the graphics rendering apparatus can render output frames of the graphics rendering context according to the graphics command associated with the virtual machine instance and its graphics rendering context, said graphics gateway comprising,
at least one transceiver;
at least one control processing unit wherein said control processing unit can route graphics commands and/or graphics data of a graphics rendering context wherein said graphic rendering context is associated with a virtual machine instance to at least one graphics rendering apparatus wherein said graphics rendering apparatus comprises a plurality of virtual graphics processing units and at least one virtual graphics processing unit is assigned to render output frames of the graphics rendering context, or said control processing unit can route graphics commands and/or graphics data of the graphics rendering context to other graphics gateway; and
random access memory wherein said memory can store graphics rendering context routing table wherein said table is used by the control processing unit to route graphics commands and/or graphics data.

18. The apparatus in claim 17 further comprising, a lookup means wherein for received graphics command and/or graphics data of a graphics rendering context, the corresponding routing destination can be retrieved by accessing said graphics rendering context routing table.
